(19) United States
(12) Patent Application Publication
(10) Pub. No.: US 2005/0219968 A1
(43) Pub. Date: Oct. 6, 2005

(54) Method for controlling disk-tray ejection

(75) Inventors: Chih-Hung Lin, Kaohsiung City (TW); Hsiang-Hao Lee, Taipei County (TW); Hung-Ping Liu, Taipei County (TW); Kun Han Yang, Taoyuan County (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/096,581

(22) Filed: Apr. 1, 2005

(30) Foreign Application Priority Data
Apr. 1, 2004 (TW) 93109066

(51) Int. Cl. G11B 7/085

(52) U.S. Cl. 369/30.27

(57) ABSTRACT

A method for controlling disk-tray ejection in an optical disk apparatus is provided. The optical disk apparatus includes a control unit and a tray that supports a disk. The method includes the steps of: (a) determining the diameter value of the disk; (b) driving the tray by the control unit with a first driving force to process the disk ejection procedure if the diameter value is a first length; and (c) driving the tray by the control unit with a second driving force to process the disk ejection procedure if the diameter is not the first length.

### CROSS-REFERENCE TO RELATED APPLICATIONS

This Application claims the right of priority based on Taiwan Patent Application No. 093109066 entitled “CONTROL METHOD OF DISK-TRAY EJECTION,” filed on Apr. 1, 2004.

### FIELD OF INVENTION

This invention relates to a method for controlling disk-tray ejection of an optical disk apparatus, and more particularly, a control method for controlling disk-ejection by determining a diameter value of a disk.

### BACKGROUND OF THE INVENTION

Disk ejection is always an important issue in a disk apparatus (e.g., a CD Driver Design). If any mistake occurs during the disk ejection procedure, it may often cause great damage by impactions or collisions between the disk and the driver. The mistake usually incurs breaks to both the disk and the driver. Thus, how to control the ejection procedure smoothly is an important topic.

FIG. 1 is a schematic view illustrating a prior art optical disk apparatus. As shown in FIG. 1, the optical disk apparatus 106 is used for reading (or writing) a disk 107. Before a reading procedure begins, the disk 107 is first put on a tray 111, and a tray motor 109 drives an ejection device 110 to control the tray moving outward or inward. A controller 108 controls the whole outward or inward movement of the tray 111. While reading the disk 107, the axial motor 103 rotates the disk 107, which is affixed by a clamp plate 101 and a rotation plate 104. A magnetic force generated by a yoke 105 and the magnet 102 attracts and helps hold the disk 107 in place.

There are many prior art disk-ejection control techniques utilizing a motor to drive the tray moving outward. There are also some designs utilizing voltage control, as shown in U.S. Pat. No. 6,621,784 B2. In this case, before the disk ejection procedure, it is necessary to determine whether a disk is disposed in the tray, and provide different driving forces according to different voltage values transmitted to the motor. Then the driving forces drives the tray moving outward.

Due to various sizes and weights of disks used nowadays, the prior art disk ejection control method cannot determine the driving force for the tray precisely. Thus, an improvement of the disk ejection control method is desirable.

### SUMMARY OF THE INVENTION

A method for controlling disk-tray ejection in an optical disk apparatus is provided. The optical disk apparatus includes a control unit and a tray for receiving the disk.

The method includes the steps of: (a) determining the diameter value of the disk; (b) driving the tray by the control unit with a first driving force to process the disk ejection procedure if the diameter value is a first length; and (c) driving the tray by the control unit with a second driving force to process the disk ejection procedure if the diameter is not the first length.

The method in accordance with the present invention can determine appropriate driving forces to the tray for different disks that have different weights and sizes. The method also can reduce the possibility of an accident occurring and makes the disk ejection procedure run smoothly.

### BRIEF DESCRIPTION OF THE DRAWINGS

FIG. 1 is a schematic view illustrating a prior art optical disk apparatus.

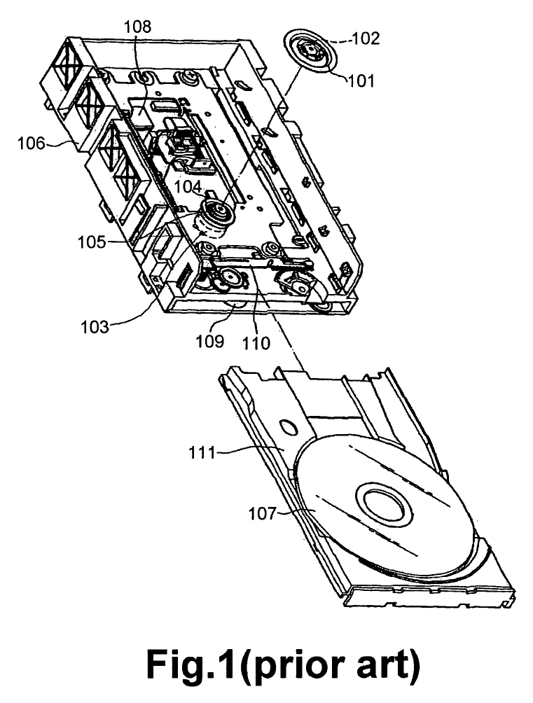

FIG. 2 is a flowchart illustrating a method in accordance with an embodiment of the present invention.

### DETAILED DESCRIPTION

A method for controlling disk-tray ejection in an optical disk apparatus is provided. The optical disk apparatus includes a control unit and a tray for receiving the disk. The method includes the steps of: (a) determining the diameter value of the disk; (b) driving the tray by the control unit with a first driving force to process the disk ejection procedure if the diameter value is a first length; and (c) driving the tray by the control unit with a second driving force to process the disk ejection procedure if the diameter is not the first length.

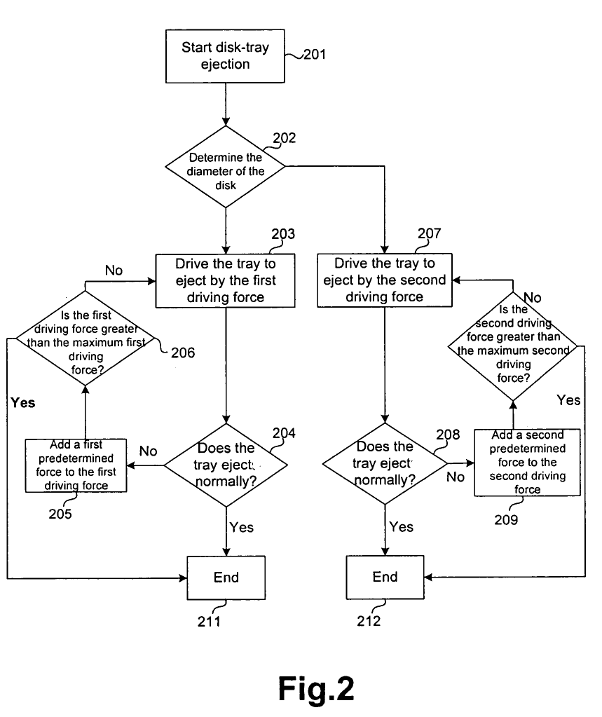

Referring to FIG. 2, when a user wants to change a disk, a disk ejection procedure is started (Step 201). Next, a diameter value of the disk is determined (Step 202). The most two popular disk sizes are 8 and 12 centimeters, which have diameter value of 8 and 12 centimeters respectively. In this embodiment, we only describe a control method to distinguish two different disks. However, in other embodiments we can distinguish numerous types of disks according to a user's demand. The difference of the rotational rate of the motor used to drive the tray between an empty-tray reading process and a disk-in-tray reading process can facilitate determining the diameter value of the disk. After recognizing the size of the disk, we can go to different processes based on the recognized size (to simplify the procedure, if the diameter value is not the first length, then regard it as the second length). As shown in FIG. 2, if the diameter value is substantially a first length, then the method proceeds to the steps described below. First, try to drive the tray by a first driving force (Step 203). The first driving force here is designed according to disks having the first diameter value, and is generated by a corresponding first voltage value (similarly, the second force corresponds to the second voltage value). Because of the different weights of different disks, the most suitable driving forces are not the same for disks of different weights. Before we figure out what driving force is most suitable, it's safer to choose the first driving force to avoid a driving force that is too large, which could cause abnormal disk ejection. In other words, the smallest driving force of all the driving forces is chosen first (the reason to choose the second driving force is the same).

If the diameter value is determined as the first length, then utilize the first driving force to move the tray. A detection unit inside the control unit starts to measure the movement of the tray in order to ensure that the disk ejection procedure runs normally (Step 204). The detection unit of the embodiment includes a timer to record a time parameter for reference to measure a state of the disk. The detection unit includes a two-way switch to measure the state of the tray. For instance, when the first driving force tries to move the tray, the timer starts counting time, then the detection unit measures the tray state immediately. If the disk ejection procedure runs normally, then the whole control ends up (Step 211). If the disk ejection procedure doesn't run normally, this means the first driving force cannot move the tray. The control unit will add the voltage value to make the first driving force become a new first driving force (Step 205). Namely, the new first driving force equals the original first driving force plus a first predetermined driving force. Then the new driving force tries to move the tray again (Step 203). Before the end of the whole process (Step 211), the detection unit keeps measuring the disk ejection state in each single specified time interval. The specified time interval can be a time interval that the normal disk ejection takes, for example, approximately one second. If the disk ejection procedure runs normally, then the whole control ends up (Step 211). If not, the control unit will add the voltage value to create another first driving force again (Step 205). The first driving force has a maximum, which is the maximum first driving force. If the present first driving force is greater than the maximum first driving force (Step 206), the disk ejection procedure stops immediately for safety concerns. For example, in the case where some mechanical problems already occurred, it would not be proper to add to the driving force anymore.

Similarly, when the diameter value is determined as a second length, a second driving force will try to move the tray. A detection unit inside the control unit starts measuring the movement of the tray in order to ensure that the disk ejection procedure runs normally (Step 208). If the disk ejection procedure runs normally, then the whole control ends up (Step 212). If the disk ejection procedure doesn't run normally, that means the second driving force cannot move the tray. The control unit will add the voltage value to make the second driving force become a new first driving force (Step 209). Namely, the new second driving force equals the original second driving force plus a second predetermined driving force. Then the new driving force tries to move the tray again (Step 207). Before the end of the whole process (Step 212), the detection unit keeps measuring the disk ejection state in each single specified time interval. If the disk ejection procedure runs normally, then the whole control ends up (Step 212). If not, the control unit will add the voltage value to create another second driving force again (Step 209). The second driving force has a maximum, which is the maximum second driving force. If the present second driving force is greater than the maximum second driving force (Step 210), the disk ejection procedure stops immediately for safety concern. Because there could be some mechanical problems that already occurred, it would not be proper to add to the driving force anymore.

The foregoing estimation can utilize the different voltage values in the control unit to decide whether the driving force exceeds the maximum driving force or not. In other words, if a current voltage value exceeds the maximum voltage value but still cannot move the tray, the disk ejection procedure has to end up immediately.

While the invention has been described in connection with what is presently considered to be the most practical and preferred embodiments, it is to be understood that the invention is not to be limited to these embodiments. The invention is intended to cover various modifications and equivalent arrangements within the spirit and scope of the appended claims.

1. A method for controlling disk-tray ejection of an optical disk apparatus, the optical disk apparatus including a control unit and a tray that supports a disk, the method comprising:
determining a diameter value of the disk;
driving the tray by the control unit using a first driving force to eject the tray if the diameter value is substantially a first length; and
driving the tray by the control unit using a second driving force to eject the tray if the diameter is not substantially the first length.

2. The method according to claim 1, further comprising:
updating the first driving force by adding a first predetermined force and trying to drive the tray again if the first driving force cannot drive the tray; and
updating the second driving force by adding a second predetermined force and trying to drive the tray again if the second driving force cannot drive the tray.

3. The method according to claim 2, wherein the first driving force is generated according to a corresponding first voltage value and the second driving force is generated according to a corresponding second voltage value, and the first and the second predetermined forces are generated according to a corresponding first predetermined voltage value and a corresponding second predetermined voltage value respectively.

4. The method according to claim 3, further comprising:
stopping disk-tray ejection if the first voltage value is not less than a maximum first voltage value and the tray cannot move; and
stopping disk-tray ejection if the second voltage value is not less than a maximum second voltage value and the tray cannot move.

5. The method according to claim 2, wherein the optical disk apparatus includes a detection unit for determining if the tray ejects normally.

6. The method according to claim 5, wherein the detection unit measures a time parameter to determine a state of disk-tray ejection.

7. The method according to claim 6, wherein the detection unit first measures at a time point of the tray starting to eject and then measures again after a specified time interval elapses, and if the tray cannot eject normally, performs the updating steps and tries to drive the tray again.

8. The method according to claim 7, wherein the specified time interval is a time period required for completion of a normal tray ejection.

9. The method according to claim 5, wherein the detection unit includes a two-way switch.

10. A method for controlling disk-tray ejection of an optical disk apparatus, the optical disk apparatus including a control unit and a tray that supports a disk, the method comprising:
driving the tray by the control unit to eject the tray using a first driving force; and
updating the first driving force by adding a first predetermined force and trying to drive the tray again, if the first driving force cannot eject the tray.

11. The method according to claim 10, further comprising:
determining a diameter value of the disk;
driving the tray by the control unit using a first driving force to eject the tray if the diameter value is substantially a first length;
driving the tray by the control unit using a second driving force to eject the tray if the diameter value is not substantially the first length;
updating the first driving force by adding a first predetermined force and trying to drive the tray again, if the first driving force cannot drive the tray; and
updating the second driving force by adding a second predetermined force and trying to drive the tray again, if the second driving force cannot drive the tray.

12. The method according to claim 11, wherein the first driving force is generated according to a corresponding first voltage value and the second driving force is generated according to a corresponding second voltage value, and the first and the second predetermined forces are generated according to a corresponding first predetermined voltage value and a corresponding second predetermined voltage value respectively.

13. The method according to claim 12, further comprising:
stopping disk-tray ejection if the first voltage value is not less than a maximum first voltage value and the tray cannot move; and
stopping disk-tray ejection if the second voltage value is not less than a maximum second voltage value and the tray cannot move.

14. The method according to claim 10, wherein the optical disk apparatus includes a detection unit for determining if the tray ejects normally.

15. The method according to claim 14, wherein the detection unit measures a time parameter to determine a state of disk-tray ejection.

16. The method according to claim 15, wherein the detection unit first measures at a time point of the tray starting to eject and then measures again after a specified time interval elapses, and if the tray cannot eject normally, performs the update steps respectively and tries to drive the tray again.

17. The method according to claim 16, wherein the specified time interval is a time period required for completion of a normal tray ejection.

18. The method according to claim 14, wherein the detection unit includes a two-way switch.
